(19) United States
(12) Patent Application Publication
(10) Pub. No.: US 2022/0270090 A1
(43) Pub. Date: Aug. 25, 2022

(54) SERVER DEVICE AND METHOD

(71) Applicant: TOSHIBA TEC KABUSHIKI KAISHA, Tokyo (JP)

(72) Inventor: Tatsuhiko Amano, Numazu Shizuoka (JP)

(21) Appl. No.: 17/522,941

(22) Filed: Nov. 10, 2021

(30) Foreign Application Priority Data
Feb. 19, 2021 (JP) 2021-025401

(51) Int. Cl. G06Q 20/40; G06Q 20/32; G06Q 20/20

(52) U.S. Cl. CPC G06Q 20/401; G06Q 20/322; G06Q 20/20

(57) ABSTRACT

According to one embodiment, a server device includes a first receiving means, a storing control means, an estimation means, and a transmitting means. The first receiving means receives settlement identification information for identifying a settlement method and portable terminal identification information for identifying a portable terminal. The storing control means stores settlement record information in which the settlement identification information and a plurality of pieces of the portable terminal identification information are correlated with each other in a storage unit. The estimation means estimates a probability that the settlement method is used for each portable terminal based on a plurality of pieces of the settlement record information stored in the storage unit. The transmission means transmits an estimation result by the estimation means.

### CROSS-REFERENCE TO RELATED APPLICATION

This application is based upon and claims the benefit of priority from Japanese Patent Application No. 2021-025401, filed on Feb. 19, 2021, the entire contents of which are incorporated herein by reference.

### FIELD

Embodiments described herein relate generally to a server device, a method, and a non-transitory computer-readable medium.

### BACKGROUND

In the related art, in a retail store such as a supermarket, information according to a user is displayed on a portable terminal by installing a dedicated application on the portable terminal of the user.

However, a user who is highly conscious of the protection of personal information dislikes installing the dedicated application on the portable terminal. For that reason, it is hard to provide information according to the user in the retail store and the like.

### DESCRIPTION OF THE DRAWINGS

FIG. 1 is a diagram illustrating an example of a notification system according to the embodiment;

FIG. 2 is a block diagram illustrating an example of a hardware configuration of a management server;

FIG. 3 is a block diagram illustrating an example of a hardware configuration of a signage terminal;

FIG. 4 is a block diagram illustrating an example of a hardware configuration of a settlement terminal;

FIG. 5 is a block diagram illustrating examples of functional configurations of the devices of the notification system;

FIG. 6 is an explanatory diagram illustrating an example of a guidance screen;

FIG. 7 is an explanatory diagram illustrating an example of a proposal screen;

FIG. 8 is a flowchart illustrating an example of a recording process executed by the settlement terminal; and

FIG. 9 is a flow chart illustrating an example of an estimation process executed by the management server.

### DETAILED DESCRIPTION

An aspect to be solved by exemplary embodiments is to provide a server device and a method capable of providing information according to a user without installing a dedicated application on a portable terminal of the user.

In general, according to one embodiment, a server device includes a first receiving means, a storing control means, an estimation means, and a transmitting means. The first receiving means receives settlement identification information for identifying a settlement method and portable terminal identification information for identifying a portable terminal. The storing control means stores settlement record information in which the settlement identification information and a plurality of pieces of the portable terminal identification information are correlated with each other in a storage unit. The estimation means estimates a probability that the settlement method is used for each portable terminal based on a plurality of pieces of the settlement record information stored in the storage unit. The transmission means transmits an estimation result by the estimation means.

Hereinafter, embodiments of a server device and a method will be described in detail with reference to the accompanying drawings. The embodiment described below is an embodiment of the server device and the method, and does not limit the configuration and specifications thereof, and the like.

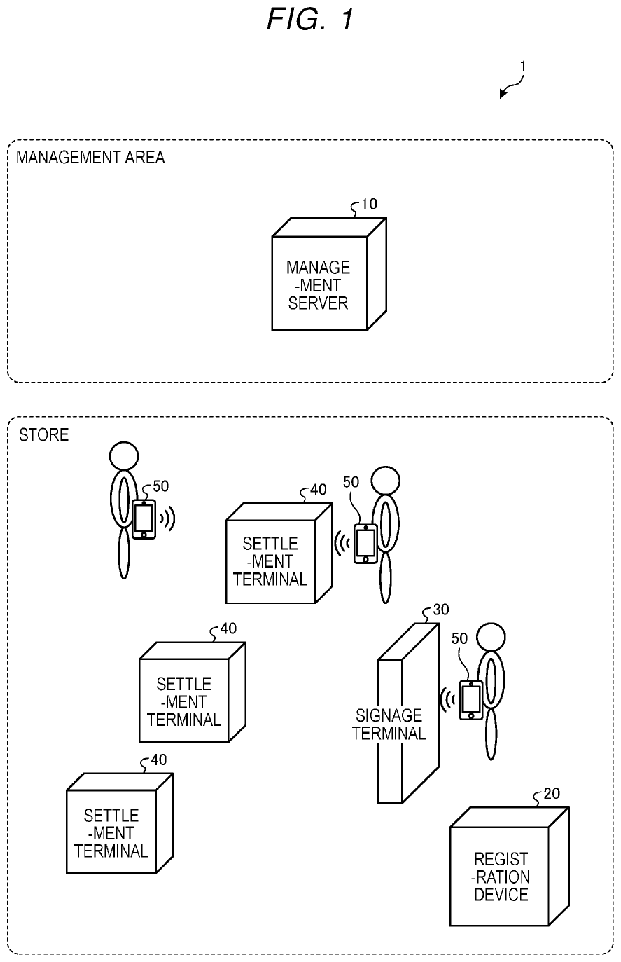

FIG. 1 is a diagram illustrating an example of a notification system 1 according to the embodiment. The notification system 1 is a system for notifying a settlement method that a customer is likely to use in a retail store or the like. The notification system 1 includes a management server 10, a registration device 20, a signage terminal 30, and a settlement terminal 40. The management server 10 is disposed in a management area where an administrator of the notification system 1 resides. The registration device 20, the signage terminal 30, and the settlement terminal 40 are disposed in the retail store. In the retail store, the settlement terminal 40 is provided for each settlement method. The settlement method is a settlement method such as cash, credit card, contactless settlement, or the like.

The management server 10, the registration device 20, the signage terminal 30, and the settlement terminal 40 are connected so as to be communicable with each other in a wired or wireless manner. The configuration of the notification system 1 illustrated in FIG. 1 is an example, and the notification system 1 may include any number of devices. The signage terminal 30 and the settlement terminal 40 can be connected to a portable terminal 50 of a user by short-range wireless communication.

The portable terminal 50 is a portable terminal such as a smartphone or a tablet terminal. The portable terminal 50 transmits portable terminal identification information for identifying the portable terminal 50 by short-range wireless communication such as Bluetooth (registered trademark). The portable terminal identification information of the portable terminal 50 is, for example, a Public Address of Bluetooth (registered trademark) Device Address, a Bluetooth (registered trademark) media access control (MAC) address, or the like. For example, the portable terminal 50 transmits a beacon including portable terminal identification information.

The registration device 20 is a device that executes a commodity registration process for registering a commodity to be sold. For example, the registration device 20 is a device such as a point of sales (POS) terminal. Then, the registration device 20 transmits commodity registration information indicating the commodity registered by the commodity registration process.

The signage terminal 30 is a display device that displays various types of information to the customer. The signage terminal 30 is an example of a first device. If the portable terminal 50 enters a reading range where communication can be made by short-range wireless communication, the signage terminal 30 receives the portable terminal identification information from the portable terminal 50. For example, the reading range is in the range of 5 meters from the signage terminal 30. The reading range may be freely changed.

The signage terminal 30 specifies a customer who is viewing the signage terminal 30 based on the portable terminal identification information. Here, in the store illustrated in FIG. 1, the settlement terminal 40 is provided for each settlement method. Therefore, the signage terminal 30 displays a screen that guides the customer to the settlement terminal 40 according to the settlement method estimated to be used by the customer.

The settlement terminal 40 is a payment device that executes payment process for paying the price of the commodity specified by the commodity registration process. The settlement terminal 40 is an example of a second device. That is, the settlement terminal 40 executes payment process based on the commodity registration information. For example, the settlement terminal 40 is a device such as a POS terminal. If the portable terminal 50 enters the reading range where communication can be made by short-range wireless communication, the settlement terminal 40 receives the portable terminal identification information from the portable terminal 50. For example, the reading range is in the range of 5 meters from the settlement terminal 40, similar to the signage terminal 30. However, the reading ranges of the settlement terminal 40 and the signage terminal 30 may be different in size from each other. The reading range may be freely changed.

The settlement terminal 40 specifies a customer using the settlement terminal 40 based on the portable terminal identification information. The settlement terminal 40 displays a settlement method estimated to be used by the customer. Then, the customer selects the settlement method.

If the settlement of the commodity is executed by the settlement method, the settlement terminal 40 transmits settlement identification information for identifying the settlement method and the portable terminal identification information to the management server 10. Here, if a plurality of customers are present around the settlement terminal 40 if the settlement is made, that is, if the plurality of portable terminals 50 exist within the reading range of the settlement terminal 40, the settlement terminal 40 receives the portable terminal identification information from each of the plurality of portable terminals 50. In this case, the settlement terminal 40 transmits the settlement identification information and the plurality of pieces of portable terminal identification information to the management server 10. In other words, if the settlement is executed, the settlement terminal 40 transmits the portable terminal identification information of the portable terminal 50 owned by the customer who is in the reading range of the settlement terminal 40 and the settlement identification information indicating the settlement method.

The management server 10 is a personal computer or a server device for cloud computing, or the like. The management server 10 is not limited to one server device, and may be configured with a plurality of server devices. If the management server 10 receives the settlement identification information and one or more pieces of portable terminal identification information from the settlement terminal 40, the management server 10 stores the settlement identification information and one or more pieces of portable terminal identification information in correlation with each other.

If the management server 10 receives an estimation request requesting estimation of the settlement method of the customer carrying the portable terminal 50 specified by the portable terminal identification information, the management server 10 estimates the settlement method of the customer. Then, the management server 10 transmits the estimation result to the signage terminal 30 and the settlement terminal 40. With this configuration, the signage terminal 30 and the settlement terminal 40 display the settlement method estimated to be used by the customer.

Next, hardware configurations of various devices in the notification system 1 will be described.

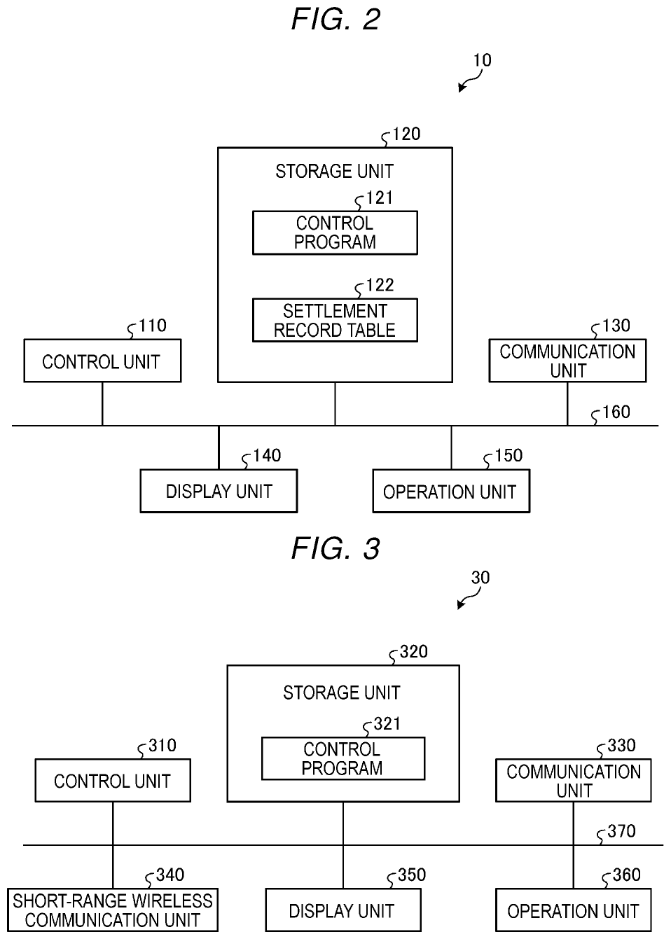

FIG. 2 is a block diagram illustrating an example of the hardware configuration of the management server 10. The management server 10 includes a control unit 110, a storage unit 120, a communication unit 130, a display unit 140, and an operation unit 150. These units are connected to each other via a system bus 160 such as a data bus or an address bus.

The control unit 110 is a computer that controls the overall operation of the management server 10 and realizes various functions of the management server 10. The control unit 110 includes a central processing unit (CPU), a read only memory (ROM), and a random access memory (RAM). The CPU comprehensively controls the operation of the management server 10. The ROM is a storage medium for storing various programs and data. The RAM is a storage medium that temporarily stores various programs and various data. Then, the CPU executes the program stored in the ROM, the storage unit 120, or the like using the RAM as a work area.

The storage unit 120 is a storage device such as a hard disk drive (HDD) or a solid state drive (SSD). The storage unit 120 stores a control program 121 and a settlement record table 122. The settlement record table 122 is not limited to the management server 10, and may be stored in another device.

The control program 121 is an operating system or a program for implementing the functions equipped in the management server 10. The control program 121 includes a program that implements a characteristic function according to the embodiment.

The settlement record table 122 is an information table in which a settlement method of settlement executed by the settlement terminal 40 and the portable terminals 50 existing around the settlement terminal 40 if the settlement is made are registered. More specifically, the settlement record table 122 includes a plurality of pieces of settlement record information in which the settlement identification information and one or more pieces of portable terminal identification information are correlated with each other.

The communication unit 130 is an interface that executes communication with an external device. For example, the communication unit 130 executes communication with the signage terminal 30 and the settlement terminal 40.

The display unit 140 is a display device that displays various screens. For example, the display unit 140 is a liquid crystal display.

The operation unit 150 is an input device such as a keyboard or a mouse that receives various operations.

FIG. 3 is a block diagram illustrating an example of the hardware configuration of the signage terminal 30. The signage terminal 30 includes a control unit 310, a storage unit 320, a communication unit 330, a short-range wireless communication unit 340, a display unit 350, and an operation unit 360. These units are connected to each other via a system bus 370 such as a data bus or an address bus.

The control unit 310 is a computer that controls the overall operation of the signage terminal 30 and realizes various functions of the signage terminal 30. The control unit 310 includes a CPU, a ROM, and a RAM. The CPU comprehensively controls the operation of the signage terminal 30. The ROM is a storage medium for storing various programs and data. The RAM is a storage medium that temporarily stores various programs and various data. Then, the CPU executes the program stored in the ROM, the storage unit 320, or the like using the RAM as a work area.

The storage unit 320 is a storage device such as an HDD or an SSD. The storage unit 320 stores a control program 321. The control program 321 is an operating system or a program for implementing the functions equipped in the signage terminal 30. The control program 321 includes a program that implements a characteristic function according to the embodiment.

The communication unit 330 is an interface that executes communication with an external device. For example, the communication unit 330 executes communication with the management server 10.

The short-range wireless communication unit 340 executes communication with the portable terminal 50 by short-range wireless communication such as Bluetooth (registered trademark). For example, the short-range wireless communication unit 340 receives a beacon including portable terminal identification information from the portable terminal 50.

The display unit 350 is a display device that displays various screens. For example, the display unit 350 is a liquid crystal display.

The operation unit 360 is an input device that receives various operations. For example, the operation unit 360 is a touch pad provided on the display unit 350, a hardware button, or the like.

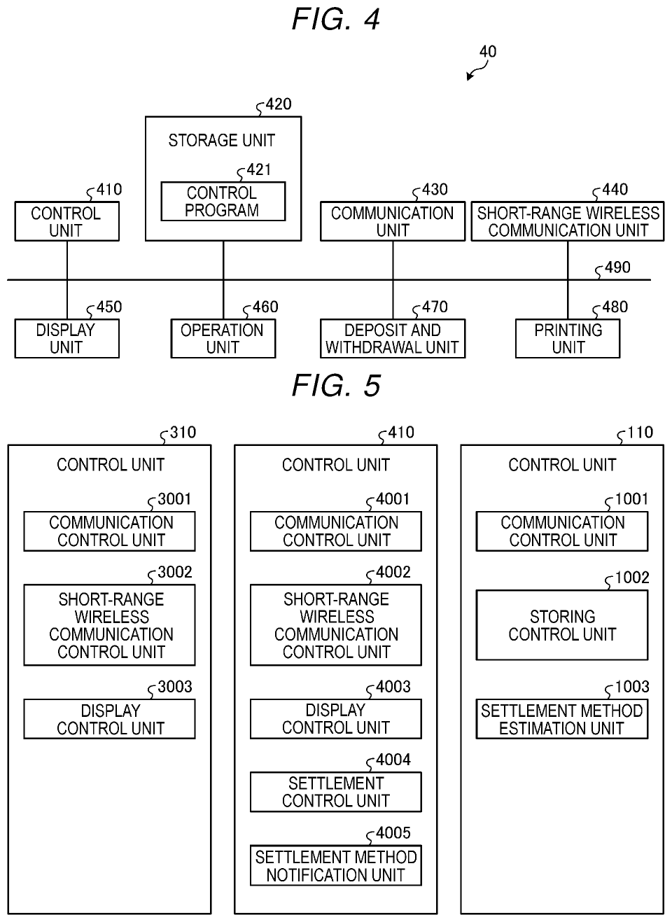

FIG. 4 is a block diagram illustrating an example of the hardware configuration of the settlement terminal 40. The settlement terminal 40 includes a control unit 410, a storage unit 420, a communication unit 430, a short-range wireless communication unit 440, a display unit 450, an operation unit 460, a deposit and withdrawal unit 470, and a printing unit 480. These units are connected to each other via a system bus 490 such as a data bus or an address bus.

The control unit 410 is a computer that controls the overall operation of the settlement terminal 40 and realizes various functions of the settlement terminal 40. The control unit 410 includes a CPU, a ROM, and a RAM. The CPU comprehensively controls the operation of the settlement terminal 40. The ROM is a storage medium for storing various programs and data. The RAM is a storage medium that temporarily stores various programs and various data. Then, the CPU executes the program stored in the ROM, the storage unit 420, or the like using the RAM as a work area.

The storage unit 420 is a storage device such as an HDD or an SSD. The storage unit 420 stores a control program 421. The control program 421 is an operating system or a program for implementing the functions equipped in the settlement terminal 40. The control program 421 includes a program that implements a characteristic function according to the embodiment.

The communication unit 430 is an interface that executes communication with an external device. For example, the communication unit 430 executes communication with the management server 10 and the registration device 20.

The short-range wireless communication unit 440 executes communication with the portable terminal 50 by short-range wireless communication such as Bluetooth (registered trademark). For example, the short-range wireless communication unit 440 receives a beacon including portable terminal identification information from the portable terminal 50.

The display unit 450 is a display device that displays various screens. For example, the display unit 450 is a liquid crystal display.

The operation unit 460 is an input device that receives various operations. For example, the operation unit 460 is a touch pad provided on the display unit 450, a hardware button, or the like.

The deposit and withdrawal unit 470 is an automatic change machine that executes deposits and withdrawals of currency in process such as payment process. The deposit and withdrawal unit 470 stores currency such as coins and banknotes deposited from a deposit port in the storage section. The deposit and withdrawal unit 470 withdraws currency such as coins and banknotes as change from a storage section to a withdrawal port.

The printing unit 480 is a printer that prints various types of information. For example, the printing unit 480 prints a receipt.

Next, the functions of each device of the notification system 1 will be described. FIG. 5 is a block diagram illustrating examples of functional configurations of the devices of the notification system 1.

The CPU in the control unit 310 of the signage terminal 30 loads the control program 321 stored in the storage unit 320 into the RAM and operates according to the control program 321 to generate each functional unit in the RAM. With this configuration, the control unit 310 of the signage terminal 30 includes a communication control unit 3001, a short-range wireless communication control unit 3002, and a display control unit 3003 as functional units.

The communication control unit 3001 controls the communication unit 330 to execute communication with the management server 10. For example, the communication control unit 3001 transmits an estimation request requesting estimation of the settlement method of the customer carrying the portable terminal 50 specified by the portable terminal identification information to the management server 10. The estimation request includes portable terminal identification information to be estimated. The communication control unit 3001 receives estimation result information including the estimation result estimated by the estimation request from the management server 10 as a response to the estimation request.

The short-range wireless communication control unit 3002 controls the short-range wireless communication unit 340 to receive the portable terminal identification information from the portable terminal 50. More specifically, if the portable terminal 50 enters the reading range where communication can be made by the short-range wireless communication, the short-range wireless communication control unit 3002 receives the portable terminal identification information from the portable terminal 50.

The display control unit 3003 controls the display unit 350 to display various screens. If the short-range wireless communication control unit 3002 receives the portable terminal identification information, the display control unit 3003 transmits an estimation request including the received portable terminal identification information to the communication control unit 3001. For example, the display control unit 3003 may transmit the estimation request each time the short-range wireless communication control unit 3002 receives the portable terminal identification information, may transmit the estimation request each time a certain period of time elapses, may transmit the estimation request if the operation unit 360 receives the operation, or may transmit the estimation request at a timing other than these timings. The estimation request may include one portable terminal identification information or may include a plurality of pieces of portable terminal identification information. For example, if the display control unit 3003 transmits the estimation request each time the portable terminal identification information is received, the display control unit 3003 transmits the estimation request including one portable terminal identification information. If the display control unit 3003 transmits the estimation request each time a certain period of time elapses, the display control unit 3003 transmits the estimation request including a plurality of pieces of portable terminal identification information.

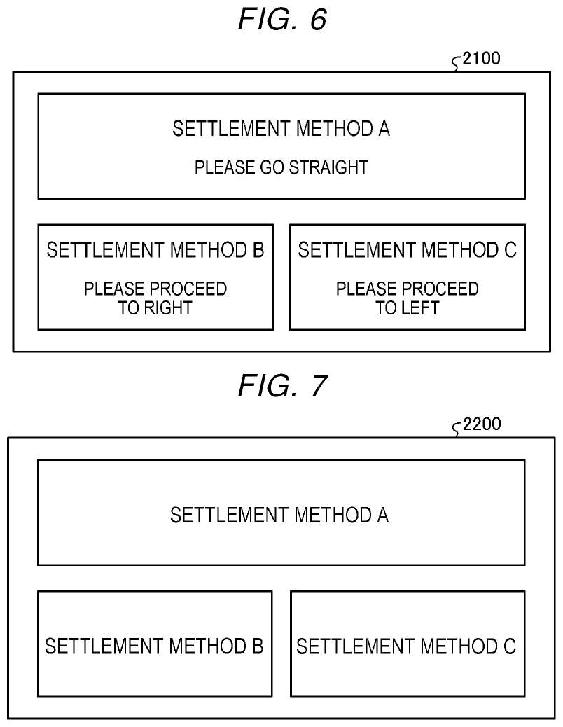

If the communication control unit 3001 receives the estimation result information, the display control unit 3003 displays a guidance screen 2100 based on the estimation result information. FIG. 6 is an explanatory diagram illustrating an example of the guidance screen 2100. The guidance screen 2100 is a screen that guides the customer to a place where the settlement terminal 40 according to the settlement method is disposed. Here, the estimation result information includes one or more pieces of settlement method information indicating a settlement method estimated to be used. A probability value to be used is set for each of the one or more pieces of settlement method information. The display control unit 3003 displays the guidance screen 2100 based on the probability values of one or more pieces of settlement method information included in the estimation result information. For example, the display control unit 3003 adjusts the size according to the probability value and displays the settlement method on the guidance screen 2100. The guidance screen 2100 illustrated in FIG. 6 indicates a state in which the probability value of settlement method A is 50%, the probability value of settlement method B is 25%, and the probability value of settlement method C is 25%. Although the guidance screen 2100 illustrated in FIG. 6 displays three settlement methods, the number of settlement methods displayed on the guidance screen 2100 may be freely changed.

The CPU in the control unit 410 of the settlement terminal 40 loads the control program 421 stored in the storage unit 420 into the RAM, and operates according to the control program 421 to generate each functional unit in the RAM. With this configuration, the control unit 410 of the settlement terminal 40 includes a communication control unit 4001, a short-range wireless communication control unit 4002, a display control unit 4003, a settlement control unit 4004, and a settlement method notification unit 4005 as functional units.

The communication control unit 4001 controls the communication unit 430 to execute communication with the management server 10. For example, the communication control unit 4001 transmits an estimation request requesting estimation of the settlement method of the customer carrying the portable terminal 50 specified by the portable terminal identification information to the management server 10. The communication control unit 4001 receives estimation result information including the estimation result estimated by the estimation request from the management server 10 as the response to the estimation request.

If the settlement is executed, the communication control unit 4001 transmits a recording request that requests recording of settlement identification information indicating the settlement method of the executed settlement and one or more pieces of portable terminal identification information received if the settlement is made to the management server 10. The communication control unit 4001 may separately transmit the settlement identification information and the one or more pieces of portable terminal identification information to the management server 10 without being limited to the recording request in which the settlement identification information and one or more pieces of portable terminal identification information are correlated with each other. In this case, the management server 10 can correlate the settlement identification information with the one or more pieces of portable terminal identification information by transmitting the time if the settlement identification information is acquired and the time if the one or more pieces of portable terminal identification information are acquired.

The short-range wireless communication control unit 4002 controls the short-range wireless communication unit 440 to receive the portable terminal identification information from the portable terminal 50. More specifically, if the portable terminal 50 enters the reading range where communication can be made by the short-range wireless communication, the short-range wireless communication control unit 4002 receives the portable terminal identification information from the portable terminal 50. The short-range wireless communication control unit 4002 stores the received portable terminal identification information in the storage unit 420 or the like.

The display control unit 4003 controls the display unit 450 to display various screens. If the short-range wireless communication control unit 4002 receives the portable terminal identification information, the display control unit 4003 transmits the estimation request including the received portable terminal identification information to the communication control unit 4001. For example, the display control unit 4003 may transmit an estimation request each time the short-range wireless communication control unit 4002 receives the portable terminal identification information, may transmit an estimation request if the operation unit 460 receives the operation, or may transmit an estimation request at a timing other than these timings.

If the communication control unit 4001 receives the estimation result information, the display control unit 4003 displays a proposal screen 2200 based on the estimation result information. FIG. 7 is an explanatory diagram illustrating an example of the proposal screen 2200. The proposal screen 2200 is a screen that provides a settlement method. The display control unit 4003 displays the proposal screen 2200 based on the probability value of one or more pieces of settlement method information included in the estimation result information. For example, the display control unit 4003 adjusts the size according to the probability value and displays the settlement method on the proposal screen 2200. The proposal screen 2200 illustrated in FIG. 7 indicates a state in which the probability value of settlement method A is 50%, the probability value of settlement method B is 25%, and the probability value of settlement method C is 25%. Although the proposal screen 2200 illustrated in FIG. 7 displays three settlement methods, the number of settlement methods displayed on the proposal screen 2200 may be freely changed.

The settlement control unit 4004 executes the settlement for paying the price of the commodity subjected to commodity registration process of the registration device 20. More specifically, the settlement control unit 4004 receives an operation of acquiring commodity registration information indicating a commodity registered by the commodity registration process. For example, the settlement control unit 4004 receives an operation of inputting identification information indicating the commodity registration information. If the settlement control unit 4004 includes a reading device such as a scanner, the settlement control unit 4004 may acquire the commodity registration information by reading a two-dimensional code. Then, the settlement control unit 4004 executes the settlement for paying the price of the commodity included in the commodity registration information. For example, the settlement control unit 4004 executes the settlement by the settlement method selected on the proposal screen 2200.

If the settlement control unit 4004 executes the settlement, the settlement method notification unit 4005 transmits a recording request to the communication control unit 4001. More specifically, if the settlement control unit 4004 executes the settlement, the settlement method notification unit 4005 specifies the portable terminal identification information received by the short-range wireless communication control unit 4002 if the settlement is made. Here, the time of settlement for specifying the portable terminal identification information is not limited to the same as the time of settlement, and may be within the predetermined time from the time of settlement. For example, the settlement method notification unit 4005 may specify the portable terminal identification information, which is received within the set time before and after the settlement is made, as the portable terminal identification information received if the settlement is made. Then, the settlement method notification unit 4005 transmits a recording request including the settlement identification information indicating the settlement method of settlement executed by the settlement control unit 4004 and one or a plurality of pieces of portable terminal identification information received by the short-range wireless communication control unit 4002 if the settlement is made to the communication control unit 4001.

The CPU in the control unit 110 of the management server 10 loads the control program 121 stored in the storage unit 120 into the RAM, and operates according to the control program 121 to generate each functional unit in the RAM. With this configuration, the control unit 110 of the management server 10 includes a communication control unit 1001, a storing control unit 1002, and a settlement method estimation unit 1003 as functional units.

The communication control unit 1001 controls the communication unit 130 to execute communication with the signage terminal 30 and the settlement terminal 40. The communication control unit 1001 receives the estimation request requesting estimation of the settlement method of the customer carrying the portable terminal 50 specified by the portable terminal identification information. The communication control unit 1001 is an example of a second receiving portion. For example, the communication control unit 1001 receives the estimation request from the signage terminal 30 or the settlement terminal 40.

If the estimate request is received, the communication control unit 1001 transmits, as a response, the estimation result information including the estimation result of the settlement method estimated to be used by the customer carrying the portable terminal 50 specified by the portable terminal identification information included in the estimation request. The communication control unit 1001 transmits the estimation result by the settlement method estimation unit 1003. The communication control unit 1001 is an example of a transmission portion. For example, the communication control unit 1001 transmits the estimation result by the settlement method estimation unit 1003 to the signage terminal 30 and the settlement terminal 40.

The communication control unit 1001 receives the settlement identification information for identifying the settlement method and the portable terminal identification information for identifying the portable terminal 50. The communication control unit 1001 is an example of the first receiving portion. That is, the communication control unit 1001 receives the recording request including the settlement identification information and the one or more pieces of portable terminal identification information from the settlement terminal 40.

The storing control unit 1002 stores the settlement record information in which the settlement identification information and the plurality of pieces of portable terminal identification information are correlated with each other in the storage unit 120. The storing control unit 1002 is an example of a storing control portion. More specifically, if the communication control unit 1001 receives the recording request including the settlement identification information and the one or more pieces of portable terminal identification information, the storing control unit 1002 stores the settlement record information in which the settlement identification information and one or more pieces of portable terminal identification information of the recording request are correlated with each other in the settlement record table 122. Alternatively, if the settlement identification information and the one or more pieces of portable terminal identification information are received separately, the storing control unit 1002 stores the settlement record information in which the settlement identification information and the portable terminal identification information, which is received within the set time centering on the time of settlement if settlement of settlement identification information is executed, are correlated with each other in the settlement record table 122.

The settlement method estimation unit 1003 estimates a probability that the settlement method is used for each portable terminal 50 based on the plurality of pieces of settlement record information stored in the storage unit 120. The settlement method estimation unit 1003 is an example of an estimation portion. That is, the settlement method estimation unit 1003 estimates the settlement method used by the customer who owns the portable terminal 50 that is a target of the estimation request received by the communication control unit 1001.

Here, the customer rarely changes the settlement method for each settlement, and generally makes a settlement by a specific settlement method. If a specific customer makes a settlement, customers around the specific customer are generally different each time. For that reason, if the settlement record information in which the settlement identification information and one or more pieces of portable terminal identification information are correlated with each other is collected and stored in the settlement record table 122, a ratio of specific settlement identification information correlated with the portable terminal identification information in the settlement record table 122 increases.

Therefore, the settlement method estimation unit 1003 estimates the settlement method based on the number of pieces of settlement identification information correlated with the portable terminal identification information indicating the portable terminal 50 that is the target of the estimation request, among the settlement record information in the settlement record table 122. That is, the settlement method estimation unit 1003 estimates the settlement method based on the ratio of the settlement identification information correlated with the portable terminal identification information of the estimation request in the settlement record information in the settlement record table 122.

If the settlement method is estimated, the settlement method estimation unit 1003 transmits the estimation result information including the estimation result to the communication control unit 1001. The estimation result information includes a probability value with which settlement is made by each settlement method as the estimation result. The estimation result information is not limited to the probability value, and may include information indicating a high-ranking settlement method with a high probability of being used, may be the order of settlement methods according to the probability of being used, or may be information other than these information.

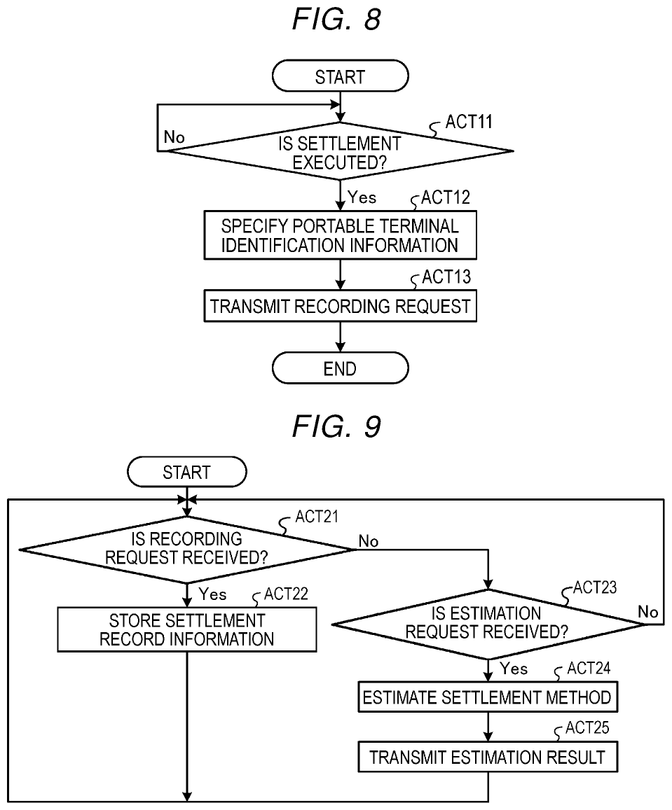

Next, the recording process executed by the settlement terminal 40 will be described. Here, FIG. 8 is a flowchart illustrating an example of the recording process executed by the settlement terminal 40 of the embodiment.

The settlement control unit 4004 determines whether or not settlement is executed (ACT 11).

If the settlement is not executed (No in ACT 11), the settlement control unit 4004 waits in ACT 11.

If the settlement is executed (Yes in ACT 11), the settlement method notification unit 4005 specifies the portable terminal identification information received if the settlement is made (ACT 12).

The settlement method notification unit 4005 transmits a recording request including settlement identification information indicating the settlement method of executed settlement and specified portable terminal identification information to the management server 10 (ACT 13).

As a result, the settlement terminal 40 ends the recording process.

Next, an estimation process executed by the management server 10 will be described. Here, FIG. 9 is a flowchart illustrating an example of the estimation process executed by the management server 10 of the embodiment.

The communication control unit 1001 determines whether or not a recording request is received (ACT 21).

If the recording request is received (Yes in ACT 21), the storing control unit 1002 stores settlement record information in which the settlement identification information of the recording request and one or more pieces of portable terminal identification information are correlated with each other in the storage unit 120 (ACT 22). That is, the storing control unit 1002 registers the settlement record information in the settlement record table 122.

If the recording request is not received (No in ACT 21), the communication control unit 1001 determines whether or not the estimation request is received (ACT 23). If the estimation request is not received (No in ACT 23), the communication control unit 1001 proceeds to ACT 21.

If the estimation request is received (Yes in ACT 23), the settlement method estimation unit 1003 estimates the settlement method used by the customer carrying the portable terminal 50 specified by the portable terminal identification information included in the estimation request (ACT 24). For example, the settlement method estimation unit 1003 estimates the probability value of the settlement method used by the customer.

The communication control unit 1001 transmits the estimation result to the signage terminal 30 and the settlement terminal 40 that transmit the estimation request (ACT 25).

Then, the management server 10 proceeds to ACT 21.

As described above, the management server 10 according to the embodiment, receives the settlement identification information for identifying the settlement method and the plurality of pieces of portable terminal identification information for identifying the portable terminals 50. The management server 10 registers the settlement identification information and the plurality of pieces of portable terminal identification information in the settlement record table 122 in correlation with each other. The management server 10 estimates the probability that the settlement method is used for each portable terminal 50 based on the settlement record table 122. Then, the management server 10 transmits the estimation result to the signage terminal 30 and the settlement terminal 40. As a result, the signage terminal 30 and the settlement terminal 40 can notify the settlement method according to the user who owns the portable terminal 50. That is, the management server 10 can provide information according to the user without installing a dedicated application on the portable terminal 50 of the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The program executed by each device of the embodiment described above or a modification example is provided by incorporating the program into a storage medium (ROM or storage unit) provided in each device in advance, but is not limited thereto. For example, a configuration in which the program may be provided by being recorded on a computer-readable recording medium such as a CD-ROM, flexible disc (FD), CD-R, or digital versatile disk (DVD) in a file of an installable or executable format may be adopted. Furthermore, the storage medium is not limited to a medium independent of a computer or an embedded system, but also includes a storage medium in which a program transmitted over a local area network (LAN), the Internet, or the like is downloaded and stored or temporarily stored.

A configuration in which the program executed by each device of the embodiment described above or a modification example is stored on a computer connected to a network such as the Internet and provided by downloading via the network may be adopted, or a configuration in which the program is provided or distributed via a network such as the Internet may be adopted.

What is claimed is:

1. A server device comprising:
a first receiver for receiving settlement identification information for identifying a settlement method and portable terminal identification information for identifying a portable terminal;
a storing controller for storing settlement record information in which the settlement identification information and a plurality of pieces of the portable terminal identification information are correlated with each other in a storage component;
an estimation component for estimating a probability that the settlement method is used for each portable terminal based on a plurality of pieces of the settlement record information stored in the storage component; and
a transmission component for transmitting an estimation result by the estimation component.

2. The server device according to claim 1, further comprising:
a second receiver for receiving an estimation request requesting an estimation of the settlement method of a customer carrying the portable terminal specified by the portable terminal identification information, wherein
the estimation component estimates the settlement method used by the customer carrying the portable terminal that is a target of the estimation request received by the second receiver, and
the transmitting component transmits the estimation result by the estimation component.

3. The server device according to claim 2, wherein
the second receiver receives the estimation request from a first device that displays a guidance screen that guides the customer to a place where a settlement terminal according to the settlement method is disposed, and
the transmitting component transmits the estimation result by the estimation component to the first device.

4. The server device according to claim 2, wherein
the second receiver receives the estimation request from a second device that displays a proposal screen that provides the settlement method, and
the transmitting component transmits the estimation result by the estimation component to the second device.

5. The server device according to claim 2, wherein
the estimation component estimates the settlement method based on the number of pieces of settlement identification information correlated with the portable terminal identification information indicating the portable terminal that is the target of the estimation request among the settlement record information.

6. The server device according to claim 1, further comprising:
a display controller that controls a display to display various screens.

7. The server device according to claim 1, further comprising:
a settlement controller that executes settlement.

8. The server device according to claim 1, wherein
the server device is a cloud computing device.

9. A method executed by a processor of a server device, comprising:
receiving settlement identification information for identifying a settlement method and portable terminal identification information for identifying a portable terminal;
storing settlement record information in which the settlement identification information and a plurality of pieces of the portable terminal identification information are correlated with each other in a storage component;
estimating a probability that the settlement method is used for each portable terminal based on a plurality of pieces of the settlement record information stored in the storage component; and
transmitting an estimation result of the estimating.

10. The method according to claim 9, further comprising:
receiving an estimation request requesting an estimation of the settlement method of a customer carrying the portable terminal specified by the portable terminal identification information;
estimating the settlement method used by the customer carrying the portable terminal that is a target of the estimation request received; and
transmitting the estimation result.

11. The method according to claim 10, further comprising:
receiving the estimation request from a first device that displays a guidance screen that guides the customer to a place where a settlement terminal according to the settlement method is disposed; and
transmitting the estimation result by the estimation component to the first device.

12. The method according to claim 10, further comprising:
receiving the estimation request from a second device that displays a proposal screen that provides the settlement method; and
transmitting the estimation result to the second device.

13. The method according to claim 10, further comprising:
estimating the settlement method based on the number of pieces of settlement identification information correlated with the portable terminal identification information indicating the portable terminal that is the target of the estimation request among the settlement record information.

14. The method according to claim 9, further comprising:
executing settlement.

15. A non-transitory computer-readable medium having stored thereon executable instructions that, in response to execution by a processor, causes a memory system to perform operations, the operations comprising:
receiving settlement identification information for identifying a settlement method and portable terminal identification information for identifying a portable terminal;
storing settlement record information in which the settlement identification information and a plurality of pieces of the portable terminal identification information are correlated with each other in a storage component;
estimating a probability that the settlement method is used for each portable terminal based on a plurality of pieces of the settlement record information stored in the storage component; and
transmitting an estimation result of the estimating.

16. The non-transitory computer-readable medium according to claim 15, further comprising:
receiving an estimation request requesting an estimation of the settlement method of a customer carrying the portable terminal specified by the portable terminal identification information;
estimating the settlement method used by the customer carrying the portable terminal that is a target of the estimation request received; and
transmitting the estimation result.

17. The non-transitory computer-readable medium according to claim 16, further comprising:
receiving the estimation request from a first device that displays a guidance screen that guides the customer to a place where a settlement terminal according to the settlement method is disposed; and
transmitting the estimation result by the estimation component to the first device.

18. The non-transitory computer-readable medium according to claim 16, further comprising:
receiving the estimation request from a second device that displays a proposal screen that provides the settlement method; and
transmitting the estimation result to the second device.

19. The non-transitory computer-readable medium according to claim 15, further comprising:
estimating the settlement method based on the number of pieces of settlement identification information correlated with the portable terminal identification information indicating the portable terminal that is the target of the estimation request among the settlement record information.

20. The non-transitory computer-readable medium according to claim 15, further comprising:
executing settlement.
